(19) United States
(12) Patent Application Publication
(10) Pub. No.: US 2009/0229567 A1
(43) Pub. Date: Sep. 17, 2009

(54) SAFETY LOCKOUT DEVICE

(76) Inventor: Garth Edgar Taylor, Dannevirke (NZ)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/300,856

(22) PCT Filed: May 17, 2007
(86) PCT No.: PCT/NZ2007/000117

§ 371 Date: May 22, 2009

(30) Foreign Application Priority Data
May 17, 2006 (NZ) 547248
Jul. 28, 2006 (NZ) 548812

(51) Int. Cl. F02D 11/02; F16K 31/44

(52) U.S. Cl. 123/339.13; 251/231

(57) ABSTRACT

A safety lockout device for a level throttle control of a vehicle includes a rocker or toggle stop mounted to be engageable with a throttle arm to lock out movement of the arm. A release is connected to the stop so as to move the stop against a restorative form applied by a biasing element away from the arm and permit the throttle to be operated. Upon the throttle arm moving back to an idle position the biasing element moves the stop back to its lock out position.

### BACKGROUND TO THE INVENTION

This invention relates to a safety lockout device for a lever throttle control of a motor vehicle. While the invention has particular application with four wheel all-terrain vehicles (“ATV”) it has application with other vehicles which have a lever operated throttle control adjacent a hand grip on the handle bar of the vehicle. An example of such other vehicle is the so-called “jet-ski”.

The ATV is a vehicle which is used in a wide range of applications though it is more commonly used in the farming industry because of its versatility. Unfortunately it is a vehicle which figures highly in statistics relating to injury or death though this is not necessarily a reflection of the vehicle being unsafe but rather the manner in which the vehicle is used by some operators.

The throttle control on an ATV is by way of a lever which is situated adjacent one of the hand grips on the handle bars of the ATV. Unfortunately, because of the positioning of the lever it can be accidentally operated by a rider of the ATV. For example, in the farming industry it is not uncommon for the ATV rider to lean forward (while standing on the ATV foot pegs/foot support surfaces) to, say, unlatch a gate or carry out some other farm related operation. In doing so it is possible for the upper leg or lower torso of the rider to push against the lever and hence move the lever forward. This can cause the ATV to move forward (or rearward if the ATV is in reverse gear) often at severe acceleration. This can directly lead to injury or, in extreme cases, death of the rider and/or a bystander.

There are other situations where accidental operation of the throttle lever can see the throttle lever move from its rest or idle position to a position where the ATV is caused to move often under severe acceleration. For example there are recorded instances of a young child sitting on the ATV (with engine going) playing with the controls and accidentally operating the throttle lever. Unfortunately in at least one instance this has resulted in death of the child.

Other vehicles with handle bars and a lever operated throttle have led to death or injury for similar reasons. One example is the so-called jet-ski where it is also too easy to knock or move the throttle lever such as to cause the machine to unexpectedly lurch forward/back and at somewhat high acceleration.

### SUMMARY OF THE INVENTION

The object of the present invention is thus to provide a safety lockout device for the throttle control of a vehicle which has a lever type throttle control the device being operative to lock out use of the throttle when the throttle has been moved to an idle or rest position.

Broadly, in one aspect of the invention there is provided a safety lockout device for a lever throttle control of a vehicle, the device including a moveable stop adapted to fit within a housing of the lever operated throttle control, the stop having an engagement portion, a release coupled to the stop and accessible externally of the housing and biasing means to bias the stop into a lockout position whereby upon an arm of the throttle control, which is connected to the throttle lever, moving to an idle or rest position, the stop moves to a lockout position in which the engagement portion is engageable with the arm to restrict movement thereof until moved to a non-engageable position by the release.

In another aspect of the invention there is provided a lever operated throttle control device which includes a housing mountable on a handlebar of a vehicle, an externally accessible throttle lever, an internally mounted arm coupled to the throttle lever, a moveable stop within the housing the stop having an engagement portion engageable with the arm, an externally located release coupled to the stop and biasing means to bias the stop into engagement with the arm upon the arm moving to a rest or idle position but releasable from such engagement position by the operation of the release.

In the preferred form the moveable stop is a rocker or toggle with a pivot axle mountable with the housing.

A part of the stop distal from the axis of pivot forms the engagement portion. This distal part can be profiled to form a secure engagement with the arm. The profile can be a rebated part of the distal end so that surfaces of the rebated part engage with a face surface and edge of the arm.

The bias means can be a spring. In one preferred form the spring can be a coil spring engaged on the rocker/toggle axle with one leg coupled to the rocker/toggle and the second leg engaged with some fixed part of the housing.

The release can be a release pad, knob, button or the like coupled to or forming part of a pin, shaft or the like, which is slidingly engageable in a bore through a wall of the housing with an inner end thereof in contact with the rocker or toggle.

In one preferred form of the invention the moveable stop is coupled to a mounting element which is adapted for mounting between the housing and a housing cover. The mounting element can be of a form which substantially replicates a thick gasket fitted between the housing cover and the edge of the wall of the housing.

In one form a spring or resilient biasing element is carried by the housing cover and acts on the moveable stop. In another form a spring is carried by the mounting element and acts on the moveable stop.

### BRIEF DESCRIPTION OF THE DRAWINGS

In the following more detailed description of the invention reference will be made to preferred embodiments of the lockout device incorporating the invention and reference will be made to the accompanying drawings in which:—

FIG. 1 is a perspective view of a lever throttle control, with top cover removed, showing the safety lockout device installed and in engagement in a lockout position with the throttle arm,

FIG. 2 is a further perspective view but looking from an opposite position to that of FIG. 1,

FIG. 3 is yet a further perspective view,

FIG. 4 is an elevation view,

FIG. 5 is the same view as FIG. 1 but showing the throttle lever and arm moved to a full throttle position,

FIG. 6 is an illustration of the lever throttle control incorporating the invention when mounted on a handle bar of a vehicle,

FIG. 7 is a perspective view of a mounting element and moveable stop according to a second embodiment of the invention,

FIG. 8 is a plan view of the second embodiment,

FIG. 9 is an elevation view of the second embodiment,

FIG. 10 is a side elevation view of the second embodiment, and

FIG. 11 is an exploded view of the second embodiment.

### DETAILED DESCRIPTION OF PREFERRED EMBODIMENTS OF THE INVENTION

The drawings and following description are based on the device being used in a lever throttle control of an ATV more particularly a Honda® 4-wheel ATV. This is by way of example only. Other ATV, jet-ski type vehicles where a lever throttle control is mounted on a handlebar adjacent a hand grip also commonly use a housing to which the throttle lever is mounted and in which a safety lockout device of a type employing the present invention can be installed.

In the following it is assumed that the device will be retrofitted, however, it will be appreciated by those skilled in the art that the device can equally be fitted as original equipment in a throttle control.

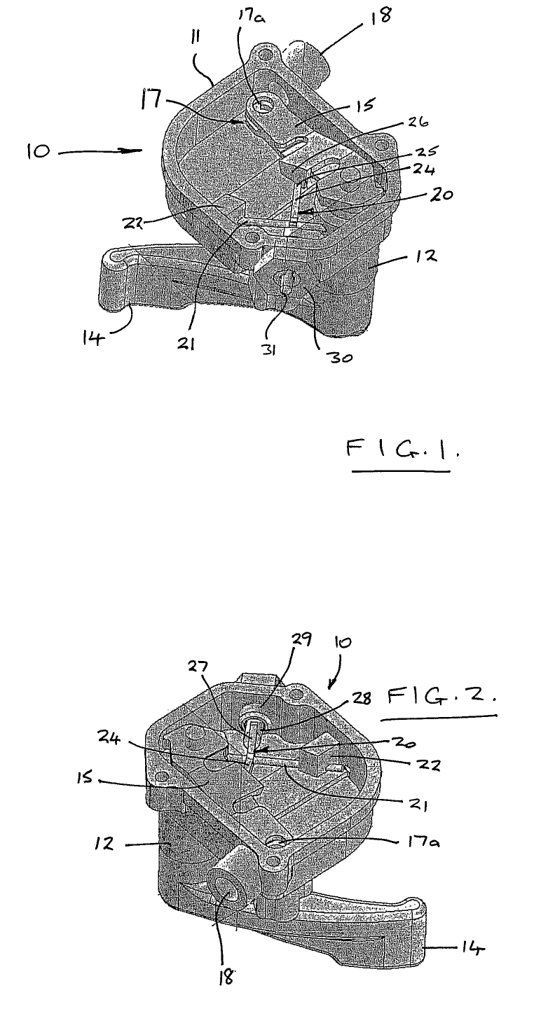

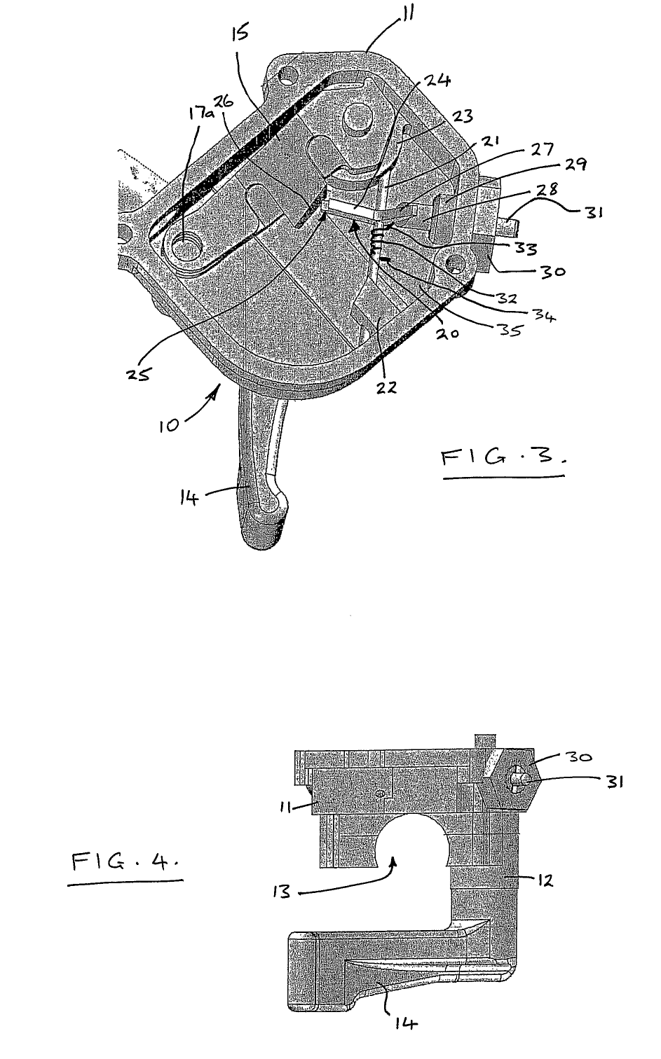

Referring to FIGS. 1 to 5 of the drawings there is shown a throttle control 10 in which the top cover 11a (see FIG. 6) has been removed in order to show the internal part of the housing 11. As is common with a throttle control 10 of this type the throttle control incorporates a housing 11 with a removable top cover. Projecting downwardly from the housing 11 is a spigot, turret or the like 12. A circular cut-out portion 13 forms with a clamp member (not shown) the means of attachment of the housing 11 to the handlebar H of the vehicle.

Rotatably coupled via a shaft located in the spigot or turret 12 is the throttle lever 14. The shaft is connected internally of the housing 11 with a throttle arm 15. The distal end 17 of the arm 15 has a conventional coupling arrangement 17a whereby the end of a throttle cable can be engaged. The throttle cable enters into the housing 11 via an opening 18 in a wall of the housing 11.

All of this is in accordance with known construction of lever operated throttle controls.

In accordance with the present invention a toggle or rocker 20 is coupled to or fixed to an axle 21. According to the present embodiment of the invention, as shown, where the lockout device is intended for retro fitting, a hole is drilled (preferably using a jig suitable for the purpose) through the wall 19 of the housing 11. The hole thus passes through an abutment 22 which forms a stop (limiting the position of the throttle arm 15 to full throttle) and through into a raised part 23 which forms part of the interior of the spigot 12. The aligned openings in the stop 22 and raised portion 23 enable the axle 21 of the lockout device to be installed and rotatable.

In an alternative arrangement the shaft 21 is not rotatable but fits in an interference type fit in the aligned openings. In such an arrangement the rocker/toggle 20 rotates on the shaft 21. It will be appreciated by those skilled in the art that the rocker/toggle 20 will be provided with suitable pivot journals which ensure free pivoting movement of the rocker/toggle 20 on the shaft 21.

The rocker/toggle 20 has a first part 24 which projects from the axle 21 toward the throttle arm 15. The distal end 25 of first part 24 is formed into a stop which is engageable with a part of the throttle arm 15.

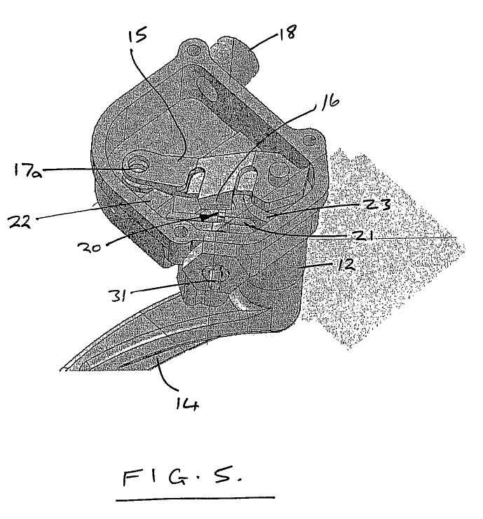

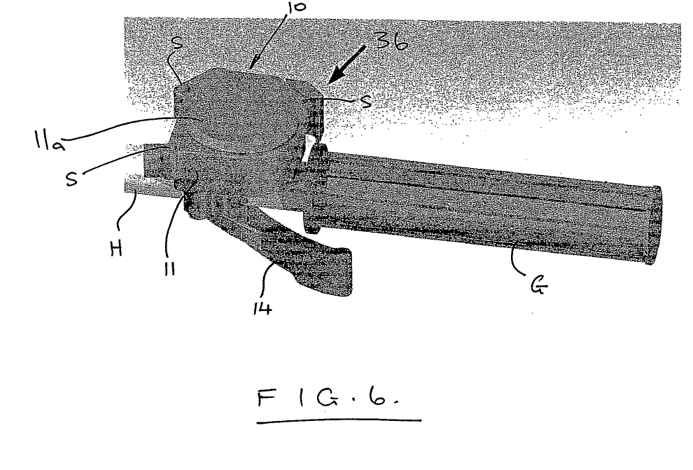

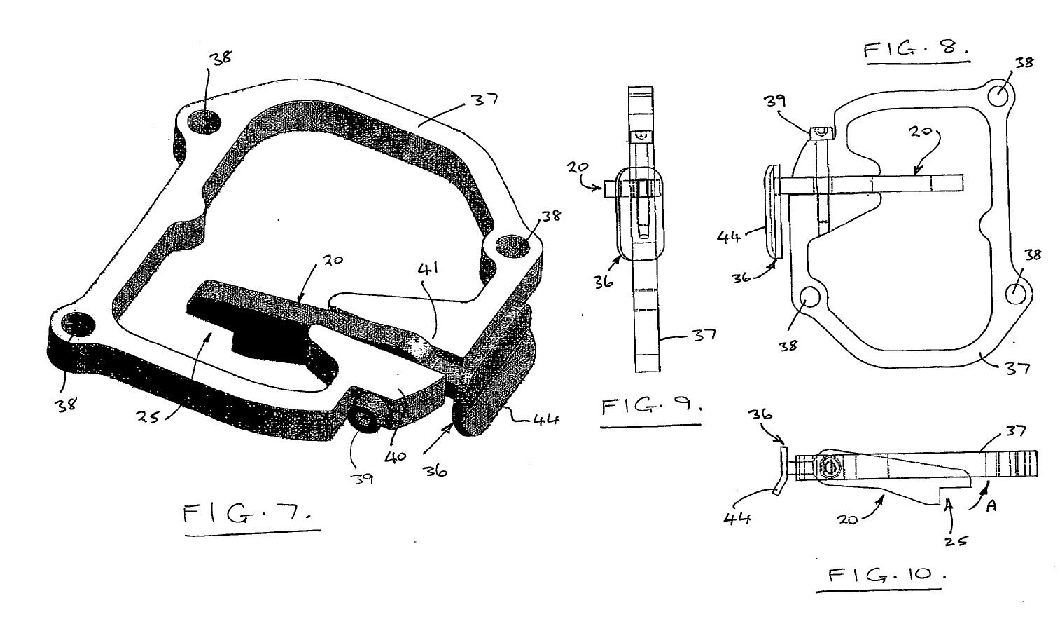

With the type of throttle control as shown in the drawings the arm 15 conveniently has a downwardly depending flange 26. It is with this flange 26 that the distal end 25 of the rocker/toggle 20 engages. Therefore, as more clearly shown in FIG. 3, the end 25 can, in one form, be rebated such that a vertical surface thereof can engage with the flange 26 while a substantially horizontal surface thereof engages under the edge of the flange 26.

This is one way of achieving a positive engagement between the rocker/toggle 20 and the arm 15. It will be appreciated by those skilled in the art there will be other ways in which this positive engagement can be achieved.

It will also be appreciated that in FIG. 3 the rebated end 25 is shown as being slightly away from its full contact with the flange 26. This is to illustrate the rebated portion but, as is evident from FIG. 1 the rebated portion fits against and under the flange 26.

To the other side of the axle 21 the rocker/toggle 20 has a second part 27 which is coupled with, attached to or formed as part of a pin, shaft or the like 28. This pin 28 is engaged in a bore (not shown) which is drilled through the wall of the housing 11.

In the case of the throttle control as illustrated a spigot 29 is formed as part of the housing wall but, if this were not present, it is anticipated that such a spigot 29 would be provided as part of the lockout device. The spigot 29 would thus have a threaded portion engageable through the opening in the wall of the housing 11 into which would be engaged a locknut 30 positioned on the external side of the wall. In this way a significant length of bearing surface can be provided to ensure stable attachment of the shaft 28 so as to not only provide correct location of the shaft 28 but ensure smooth sliding movement thereof.

The exposed or distal end 31 of the pin 28 can be of a reduced diameter but, as shown, it projects beyond the nut 30 or if such a nut is not present, beyond the outer surface of the housing. To this distal end 31 can be attached a knob, button pressure pad 36 or the like (e.g. as shown in FIG. 6).

As shown in FIG. 3 (but omitted from the other Figures) there is a coil spring 32 engaged on the shaft 21. One end 33 of the coil spring 32 engages with the rocker/toggle 20 while the other end 34 engages with a fixed part e.g. floor 35 of the housing 10. The coil spring 32 thus applies a biasing effect which causes the distal end 25 of the rocker/toggle 20 to move into an engagement or stop position as will hereinafter become apparent.

With the lockout device in the position as shown in FIGS. 1, 2 and 3 the distal end 25 of the rocker/toggle 20 engages with the flange 26. This therefore prevents movement of the throttle arm 15 and hence the throttle lever 14. The knob or pressure pad which is attached to the distal end 31 of the pin 28 is positioned so as to be immediately adjacent the hand grip G (see FIG. 6) on the handle bar H of the vehicle. Thus when the vehicle operator wishes to operate the throttle lever 14 he/she simply applies a pressure to the knob, pad 36, etc., or the like which causes the pin 28 to move inwardly thereby rotating the rocker/toggle 20 such that the profiled stop end 25 moves downwardly and clear of the flange 26.

The throttle arm 15 is thus able to slide over the first part 24 of the rocker/toggle 20 so that the throttle lever 14 can be operated normally. FIG. 5 shows, for example, the lever arm 15 moved to the full throttle position where the arm 15 is in contact with the stop 22. However, upon the lever 14 being moved back to the idle or rest position the flange 26 clears the distal end 25 of the rocker/toggle 20 so that under the bias of the spring 32 the rocker/toggle 20 reverts to its normal position where the profiled distal end 25 engages with the flange 26 to thereby once again prevent the throttle lever 14 from being operated.

The lockout device therefore provides an automatic lockout of the throttle upon the throttle being moved to the idle/rest position. Consequently, if in use of the vehicle the operator moves the vehicle to a stop position and then stands up to, say, carry out an operation such as opening of a gate, any accidental contact with the throttle lever 14 will not cause the throttle lever 14 to move because of the lockout effect of the safety device. However, upon completing the operation and wishing to once again move the vehicle the operator simply applies pressure to the knob, pad or the like 36 and then operates the throttle lever 14 as normal.

The safety lockout device also means that if a young child is playing with the controls of the ATV (with the motor running) it is unlikely that that child would know how to operate the lockout device or to be able to operate the lockout device and simultaneously move the throttle lever 14. As a consequence the safety device provides a means of preventing a young child from accidentally operating the throttle.

As illustrated and described herein the lockout device can be retro fitted. Equally it can be manufactured into a form which is part of the throttle control as manufactured.

As will be appreciate by those skilled in the art the invention is open to modification into forms in which the inventive concept can equally be incorporated. One such modification is to provide the lock out device in a form which is more easily retro fitted to a throttle control 10. Such a modified form of the invention is shown according to a second embodiment in FIGS. 7-11 of the accompanying drawings. This second embodiment is intended for retro fitting to the housing 11 of a throttle control 10 of the type shown in FIGS. 1-6.

According to this embodiment of the invention there is provided a mounting element 37 which, as is apparent from FIGS. 7 and 8, is shaped to substantially conform with the shape of the edge profile of the wall of throttle housing 11 onto which the housing cover 11a is fitted. The mounting element 37, therefore, essentially takes on the form of a somewhat thick gasket which is mounted between the edge of the housing 11 and the housing cover 11a. To this end, openings 38 are formed in the mounting element 37 for reception of the screws S which normally mount the cover 11a to the housing 11.

In the preferred form of the invention the mounting element 37 is formed of a metal material though equally it could be moulded from a suitable plastic material. The thickness of the mounting element 37 is sufficient to provide a stable pivot mounting of the toggle or rocker 20.

As is apparent from FIGS. 7-11 the toggle or rocker 20 is substantially of the form shown in the first embodiment. It therefore has a shaped distal end 25 which is formed in such a manner as to be engageable with a part of the throttle arm 15. The rocker/toggle 20 is also pivotally mounted by an axle 21 which in this form of the invention can be a cap screw 39 engaged through one part 40 of the mounting element 37 and threaded and locked into a second part 41 of the mounting element 37. As shown in FIG. 11 a sleeve 42 is preferably located in an opening 43 in the rocker/toggle 20 and the cap screw 39 engages therethrough. In this way a free movement of rocker/toggle 20 is achieved.

The rocker/toggle 20 also includes a knob, button or more particularly a pressure pad 36. Thus when the mounting element 37 is sandwiched between the housing 11 and cover 11a the pressure pad 36 is located externally of the housing 11.

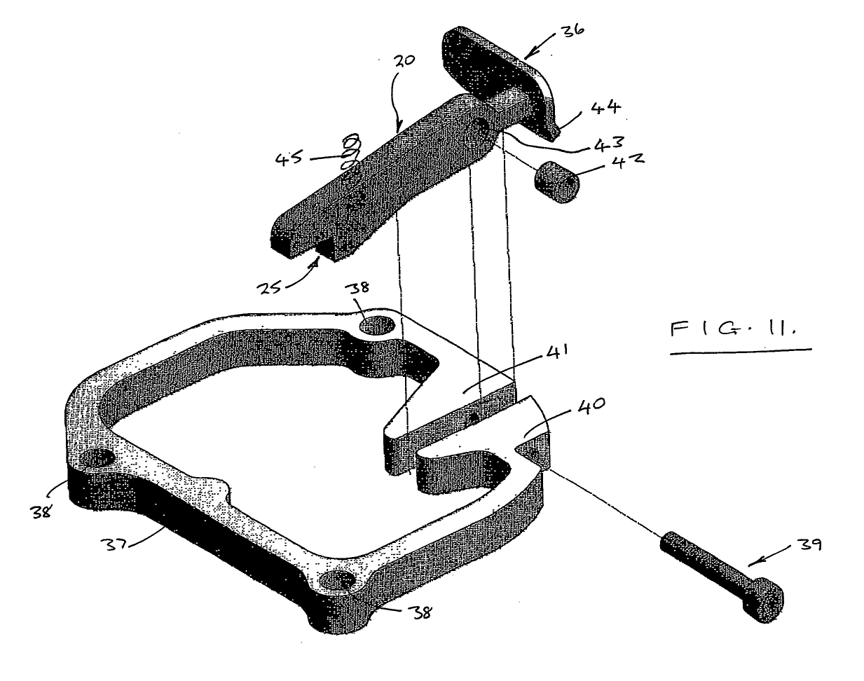

A biasing means is incorporated, as with the first embodiment, so as to bias the rocker/toggle 20 into the position where it will engage with the throttle arm 15 so as to prevent the throttle lever 14 from moving away from substantially the idle position. Thus, as with the first embodiment, the user of the vehicle will apply a pressure to the pressure pad 36 so as to cause the rocker/toggle 20 to pivot upwardly (in the direction of arrow A of FIG. 10) so that the distal end 25 clears away from the throttle arm 15 to thereby enable the throttle lever 14 to be moved.

As illustrated more clearly in FIGS. 7 and 10 the pressure pad 36 is preferably profiled with an outwardly inclined lower portion 44 so as to provide a better contact area for a user to apply a pressure to the pressure pad 36 to cause the appropriate upward pivoting A movement of the rocker/toggle 20.

In a retro fit situation the cover 11a of the throttle housing 11 would simply be removed by removing the three screws S (see FIG. 6) whereupon the cover 11a can be taken off and the mounting element 37 placed in position on the edge of the wall of the housing 11. The cover 11a can then be replaced and screwed back into position by screws S.

If desired gaskets or seals (not) shown can be included either side of the mounting element 37, these will provide a seal between the mounting element 37 and the cover 11a and edge of the housing wall respectively.

When the biasing means is a spring it can be in the form of a coil spring which is engaged between some part of the mounting element 37 and rocker/toggle 20. It is thus incorporated as part of the whole assembly thus, no further installation work needs to be carried out. It is simply a matter of putting the whole assembly in place and reinstalling the cover. Therefore, the operation is simple, straight forward and quick.

In an alternative arrangement, however, a spring biasing element could be applied to the inside surface of the cover 11a and come in contact with some part of the upper edge of the rocker/toggle 20 so as to apply a downward biasing effect. This biasing means could be in the form of say a resilient body of material adhered to the underside of the cover 11a or some form of leaf spring adhered or otherwise mounted to the underside of the cover 11a. It will be apparent to those skilled in the art that as with the first embodiment different means of applying a biasing effect to the rocker/toggle 20 can be employed.

As shown in FIG. 11 a compression spring 45 can at one end be engaged with the rocker/toggle 20 and the other end will contact the underside of the cover 11a.

It will be appreciated by those skilled in the art that other modified forms of the lock out device incorporating the inventive concept can be employed. For example in an original equipment situation the cover 11a could be formed in such a manner as to provide a place for the pivot mounting of the rocker/toggle 20 so that it becomes an integrally mounted part of the cover 11a. Thus in a manufacturing operation the lock out device would be incorporated with the cover 11a such that the cover 11a can simply be mounted onto the throttle housing 11 whereby the rocker/toggle 20 will automatically engage with the throttle arm 15 in the required manner.

The safety lockout device is open to yet further modifications as will be appreciated by those skilled in the art. For example the positioning of the rocker/toggle and its associated shaft as well as the means by which it engages with the throttle arm can be altered depending on the internal construction of the throttle control. Such modified forms of the lockout device according to the present invention fall within the scope of the invention.

Another modification can reside in the biasing means where it will be apparent to those skilled in the art that alternative means of biasing can be employed. For example, a spring element can be replaced by simply having the rocker 20 counterweighed. This can be achieved in one form of the invention by having the end of the rocker inboard of the pivot axis of shaft 21/cap screw 39 sufficiently heavy or weighed such that it will always tend to drop down into the lockout position i.e. engage with the throttle arm 15.

1-22. (canceled)

23: A lever operated throttle control device comprising:
a housing mountable as part of a throttle housing of a vehicle;
a moveable stop within the housing, the stop including an engagement portion engageable with an internally mounted arm coupled to an externally accessible throttle lever;
an externally located release coupled to the stop; and
biasing means to bias the stop into engagement with the arm upon the arm moving to a rest or idle position but releasable from such engagement position by operation of a release.

24: The device of claim 23, further comprising the internally mounted arm and an externally accessible throttle lever.

25: The device of claim 23, wherein the moveable stop includes a rocker or toggle with a pivot axle mountable with the housing.

26: The device of claim 25, wherein a part of the moveable stop distal from the axis of pivot forms the engagement portion.

27: The device of claim 26, wherein the distal part is profiled to form a positive engagement with the arm.

28: The device of claim 27, wherein the profile is a rebated part of the distal end such that the rebated part engages with a face surface and edge of the arm.

29: The device of claim 23, wherein the biasing means includes a spring.

30: The device of claim 29, wherein the spring is a coil spring engaged on the moveable stop with one leg coupled to the moveable stop and a second leg engaged with a fixture part that is fixed relative to the housing.

31: The device of claim 29, wherein the spring is engaged between a part of the housing and a part of the moveable stop.

32: The device of claim 31, wherein the part of the housing is a removable cover of the housing.

33: The device of claim 23, wherein the biasing means includes a counterweighting of the moveable stop.

34: The device of claim 23, wherein the release includes a release pad, knob, button, or the like coupled to or forming part of a pin, shaft, or the like that is slidingly engageable in a bore through a wall of the housing with an inner end thereof coupled with the moveable stop.

35: The device of claim 23, wherein the release includes a release pad, knob, button, or the like coupled directly to the moveable stop.

36: The device of claim 23, wherein the moveable stop is coupled to a mounting element that is adapted for mounting between the housing and a housing cover.

37: The device of claim 36, wherein the mounting element is of a form that substantially replicates a thick gasket arranged to fit between the housing cover and an edge of the wall of the housing.

38: The device of claim 36, wherein the bias means includes a spring or resilient biasing element carried by the housing cover and engageable with the moveable stop to apply a restoring force thereto.

39: The device of claim 36, wherein the bias means includes a spring carried by the mounting element and engaged with the stop to apply a restoring force thereto.

40: The device of claim 36, wherein the stop is pivotally engaged between two parts of the mounting element, one part of the stop to one side of the pivot axis of the stop is shaped to engage with the stop and a second part to an opposite side of the pivot axis is coupled to the release.

41: The device of claim 40, wherein the release is in a form of a release pad, knob, button, or the like.

42: The device of claim 36, wherein the mounting element includes openings through which can pass fastenings for fastening the housing cover to the housing.

43: The device of claim 36, wherein the mounting element is formed from metal or plastics material.
